(19) United States
(12) Patent Application Publication
(10) Pub. No.: US 2023/0124083 A1
(43) Pub. Date: Apr. 20, 2023

(54) DATA STACK MIPS ANALYSIS TOOL FOR DATA PLANE

(71) Applicant: ZEKU, INC., Palo Alto, CA (US)

(72) Inventors: Su-Lin LOW, San Diego, CA (US); Chun-I LEE, San Diego, CA (US); Tianan Tim MA, San Diego, CA (US); Hausting HONG, San Diego, CA (US); Hong Kui YANG, San Diego, CA (US)

(21) Appl. No.: 18/066,222

(22) Filed: Dec. 14, 2022

Related U.S. Application Data
(63) Continuation of application No. PCT/US2021/014939, filed on Jan. 25, 2021.
(60) Provisional application No. 63/039,305, filed on Jun. 15, 2020.

(51) Int. Cl. G06F 11/34

(52) U.S. Cl. CPC G06F 11/3457; G06F 11/3419

(57) ABSTRACT

Apparatus and methods for performing a Million Instructions per Second (MIPS) analysis for a data stack of a user equipment (UE) are disclosed. The method includes (i) receiving an input for a Monte Carlo simulation, the input including a requirement for one or more use cases, a processor specification, and a user-specified function; (ii) determining a traffic model, a number of packets to be run for each use case, and a seed value for the Monte Carlo simulation; (iii) performing the Monte Carlo simulation based on the input and the traffic model to generate a simulation result; and (iv) determining a recommended configuration of processor cores for the data stack based on the simulation result.

### CROSS-REFERENCE TO RELATED APPLICATION(S)

This application is a continuation of International Application No. PCT/US2021/014939 filed on Jan. 25, 2021, which claims the benefit of U.S. Provisional Patent Application Ser. No. 63/039,305, filed Jun. 15, 2020, which is incorporated by reference herein in its entirety.

### TECHNICAL FIELD

This application relates to the communications field, and more specifically, to analysis tools for assisting data plane architecture design and other applications.

### BACKGROUND

Rapid growth in computing technology is creating a greater demand for data communication. The increasing demand in turn drives further growth in communication technology, which often requires additional features, increased processing capacities, and/or increased resources within a given space. Such growth often introduces new challenges in data stack designs. MIPS has been an approximate measure to estimate a processor's raw processing power. Traditional tools perform MIPS calculations by benching marking or simple testing. These traditional MIPS calculation tools tend to be oversimplified, not accurately reflecting the actual field application, making it difficult to explore data stack design options.

### SUMMARY

The present disclosure provides apparatuses and methods for analyzing and designing the architecture of 5G (the fifth generation technology standard for broadband cellular networks) data stack. More particularly, the present disclosure provides a MIPS analysis tool to achieve the foregoing goals. The MIPS analysis tool provides a user interface enabling a user to specify multiple use cases requirements (e.g., a type of communications, data transmission rates, carriers/channels to be used, etc.), processors specifications (e.g., types of processors to be used to handle the communications), and user-specified functions. For example, the user-specified functions can include one or more of the 5G data stack functions to be implemented and details of the functions (e.g., execution frequencies).

The MIPS analysis tool performs a Monte Carlo simulation with a traffic model. The traffic model can be determined by a user or empirical data. The traffic model can include multiple packet sizes and corresponding allocation/distribution information (e.g., percentages in time) of the packets with the multiple packet sizes. To perform the Monte Carlo simulation, a total number of packets to be run for each use case and a seed value are also provided. The MIPS analysis tool then generates a simulation result. Detailed examples of the traffic model and the simulation result can be found in FIG. 5 and corresponding descriptions. Based on the simulation result, a recommended configuration of processor cores (e.g., how many processors are recommended and their types/specifications) for the data stack can be determined.

One aspect of the present disclosure is to provide a method and an apparatus for performing an MIPS analysis for a data stack of a user equipment (UE). The method includes, for example, (i) receiving an input for a Monte Carlo simulation, the input including a requirement for one or more use cases, a processor specification, and a user-specified function; (ii) determining a traffic model for the Monte Carlo simulation, the traffic model being determined based on a packet size, a number of packets to be run for each use case, and a seed value for the Monte Carlo simulation; (iii) performing the Monte Carlo simulation based on the input and the traffic model to generate a simulation result, and (iv) determining a recommended configuration of processor cores for the data stack based on the simulation result. The method may include generating, prior to performing the Monte Carlo simulation, an instruction mapping or instruction map for each of the one or more use cases. The instruction mapping can be used to calculate a total number of instructions per second per component carrier, which can be used for the Monte Carlo simulation. Examples of the total number of instructions per second per component carrier can be found in Equations A and B discussed in detail below.

In some embodiments, the present method can be implemented by a tangible, non-transitory, computer-readable medium having processor instructions stored thereon that, when executed by one or more processors, cause the one or more processors to perform one or more aspects/features of the method described herein.

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1 is a schematic diagram of a wireless communication system in accordance with one or more implementations of the present disclosure.

FIG. 2 is a schematic diagram illustrating elements of a network architecture in accordance with one or more implementations of the present disclosure.

FIG. 3 is a schematic diagram illustrating an MIPS analysis tool in accordance with one or more implementations of the present disclosure.

FIG. 4 is a flowchart illustrating processes of the components of an MIPS analysis tool in accordance with one or more implementations of the present disclosure.

FIG. 5 is a schematic diagram illustrating a user interface showing information in accordance with one or more implementations of the present disclosure.

FIG. 6 is a schematic diagram illustrating a recommended configuration of processor cores for a data stack in accordance with one or more implementations of the present disclosure.

FIG. 7 is flowchart illustrating a method in accordance with one or more implementations of the present disclosure.

FIG. 8 is a schematic block diagram of a terminal device in accordance with one or more implementations of the present disclosure.

### DETAILED DESCRIPTION

### Communications Environment

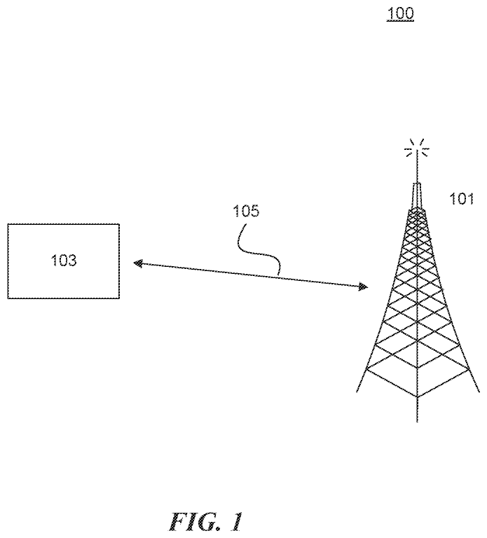

FIG. 1 illustrates a wireless communications system 100 for implementing the present layer-2 data stack solution. As shown in FIG. 1, the wireless communications system 100 can include a network device 101. Examples of the network device 110 include a base transceiver station (Base Transceiver Station, BTS), a NodeB (NodeB, NB), an evolved Node B (eNB or eNodeB), a Next Generation NodeB (gNB or gNode B), a Wireless Fidelity (Wi-Fi) access point (AP), etc. In some embodiments, the network device 110 can include a relay station, an access point, an in-vehicle device, a wearable device, and the like. The network device 110 can include wireless connection devices for communication networks such as: a Global System for Mobile Communications (GSM) network, a Code Division Multiple Access (CDMA) network, a Wideband CDMA (WCDMA) network, an LTE network, a cloud radio access network (Cloud Radio Access Network, CRAN), an Institute of Electrical and Electronics Engineers (IEEE) 802.11-based network (e.g., a Wi-Fi network), an Internet of Things (IoT) network, a device-to-device (D2D) network, a next-generation network (e.g., a 5G network), a future evolved public land mobile network (Public Land Mobile Network, PLMN), or the like. A 5G system or network may be referred to as a new radio (New Radio, NR) system or network.

As shown in FIG. 1, the wireless communications system 100 also includes a terminal device 103. The terminal device 103 can be an end-user device configured to facilitate wireless communication. The terminal device 103 can be configured to wirelessly connect to the network device 101 (via, e.g., a wireless channel 105) according to one or more corresponding communication protocols/standards. The terminal device 103 may be mobile or fixed. The terminal device 103 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 103 include a modem, a cellular phone, a smart phone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an IoT device, a terminal device in a future 5G network, a terminal device in a future evolved PLMN, or the like.

For illustrative purposes, FIG. 1 illustrates only one network device 101 and one terminal device 103 in the wireless communications system 100. However, it is understood that, in some instances, the wireless communications system 100 can include additional/other devices, such as additional instances of the network device 101 and/or the terminal device 103, a network controller, a mobility management entity/devices, etc.

### Wireless Communication Architecture

A telecommunications architecture often includes three basic components, a data plane (DP), a control plane (CP), and a management plane (MP). The control plane and the management plane serve the data plane. The data plane carries user traffic and can be named as a user plane, forwarding plane, carrier plane or bearer plane. The management plane of a networking system configures, monitors, and provides management, monitoring and configuration services to, all layers of the network stack and other parts of the system. The control plane controls routing tasks, which determine which path to use to send packets or frames. For example, the control plane populates routing tables, network topology, and forwarding tables so as to enable data plane functions.

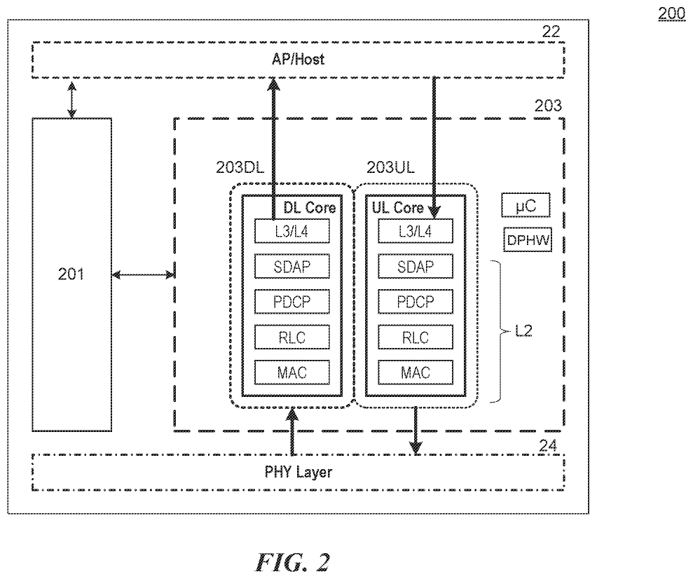

FIG. 2 is a schematic diagram illustrating elements of a network architecture 200 in accordance with one or more implementations of the present disclosure. The network architecture is for wireless communications of a 5G wireless system or device. For example, the 5G wireless system or device can be user equipment (UE) such as a modem. As shown, the network architecture 200 includes a control plane 201 and a data plane 203. The control plane 201 can be implemented by a main processor of the UE. The data plane 203 can be implemented by the main processor of the UE, a micro controller for the data plane 203, and other suitable hardware.

In some embodiments, the control plane 201 handles functions such as a Non Access Stratum (NAS) function and a Radio Resource Control (RRC) function. The NAS function handles network layer control such as mobility management, session management, security management, and system selection. The RRC function handles radio resources allocation and configuration, radio channel control of radio bearers (and logical channels), and security (such as ciphering, integrity configurations, etc.).

The data plane 203 is configured to handle layer-2 (L2), and layer-3/layer-4 (L3/L4) functions. L2 functions relate to the 3GPP protocols for packet data processing. As shown in FIG. 2, the data plane 203 includes L2 protocols as well as L3/L4 protocols. The L2 protocols include a Media Access Control (MAC) layer, a Radio Link Control (RLC) layer, a Packet Data Convergence Protocol (PDCP) layer, and a Service Data Adaptation Protocol (SDAP) layer. The L3/L4 protocols Internet Protocol (IP) packets. These layers interface with an application (AP) or host layer 22 and a physical (PHY) layer 24 to (i) process data packets, (ii) decode/encode the headers of the packets, (iii) perform radio link error recovery and retransmission schemes, as well as (iv) perform reordering, segmentation, and reassembly.

In the illustrated embodiments shown in FIG. 2, the data plane 203 can have a Downlink (DL) core 203DL and an Uplink (UL) core 203UL deployed for processing DL and UL protocol layers in a data-plane (DP) processor. In other embodiments, however, there can be more than two processing cores for processing data stack functions. For example, for 5G communications and beyond, increasing data processing needs can require more processing cores so as to effectively address this issue. These processing cores can be implemented as a main processor (e.g., of the control plane 201 of the UE), a micro controller (e.g., of the data plane 203; μC), data plane hardware (DPHW), a hardware accelerator, combinations of the foregoing, etc.

Key aspects to determine how to implement the cores (i.e., architectural designs of the control plane 201 and the data plane 203) include determining MIPS processing needs of the network architecture 200. Once the MIPS processing needs are determined, the specifics of the processing cores (e.g., processor types, characteristics, the number of processor cores, etc.) can be determined and/or designed. The MIPS analysis tool provided in the present disclose can effectively and efficiently address the foregoing needs.

### MIPS Analysis Tool

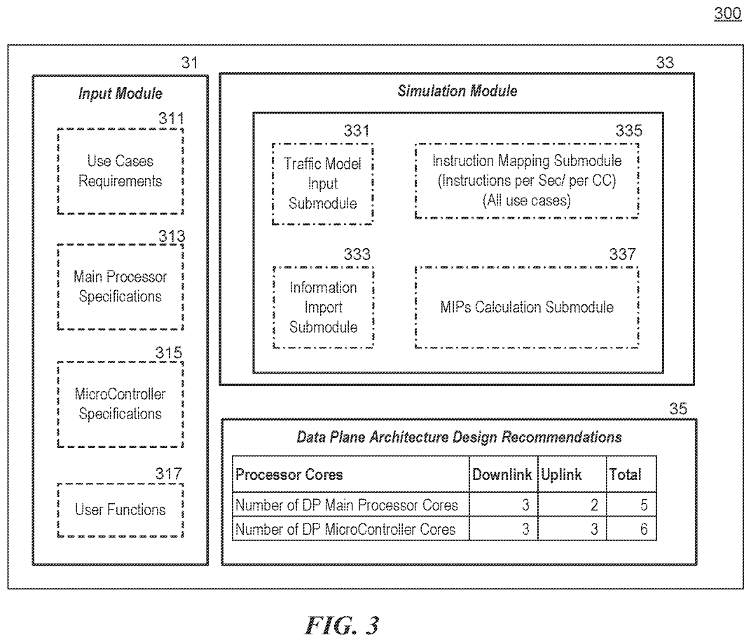

FIG. 3 is a schematic diagram illustrating an MIPS analysis tool 300 in accordance with one or more implementations of the present disclosure. As shown in FIG. 3, the MIPS analysis tool 300 includes an input module 31 (can be visually presented to a user via a user interface), a simulation module 33, and a recommendation module 55. The input module 31 is configured to receive input information (or an input) regarding which cases (or “use cases”) or scenarios are to be simulated. The simulation module 33 is configured to simulate the data processing based on the input information so as to generate a simulation result. The recommendation module 35 is configured to provide recommendations regarding configurations of processing cores for data stack architectural designs.

Input Module 31

The input module 31 is configured to receive input information from a user to specify multiple sets of information, including: use-case requirements 311 (e.g., for one or more use cases), main processor specifications 313, micro controller specification 315, and/or user functions/execution tasks 317.

In some embodiments, the use-case requirements 311 include user-specified performance requirements, such as a Radio Access Technology (RAT) Type (e.g., 5G or Long Term Evolution (LTE) communications), a maximum data rate, a SubCarrier Spacing (SCS), a number of Component Carriers (CCs), a number of Logical Channels (LCs), and/or other suitable requirements. The SCS determines a slot duration and has direct impact on the MIPS calculations. The maximum data rate indicates a maximum throughput rate that the use cases can support.

In some embodiment, the use-case requirements 311 can also include typical use cases. Examples of the typical use cases include: (1) “5G sub6 only (Maximum High Throughput)” (“5G sub6” refers to 5G deployments using spectrum under 6 GHz); (2) “5G sub6 (Low Latency);” (3) “5G sub6+LTE;” (4) “5G mmW only (Maximum High Throughput)” (“mmW” refers to “millimeter waves”); (5) “5G mmW only (Low Latency);” and (6) “5G mmW+LTE.”

The main processor specifications 313 includes specifications and capabilities of one or more main processors that are to be used in the use cases. For example, the main processor specifications 313 can include (1) a clock rate; (2) Cycles Per Instruction (CPI) (Local), percentage in time; (3) CPI (External), percentage in time; and (4) Processor Load threshold in percentage. The clock rate can be in “MHz” or “mega cycles per second.” The clock rate specifies “cycles per second” supported by the processor. For example, a processor with a higher clock rate can support more cycles per second, with an expenses of a higher power consumption. The CPI specifies the number of cycles that is needed per instruction. For example, in a case where data to be processed is in a local memory, the number of cycles needed is less than a case where the data to be processed is at a remote/external location. Accordingly, the percentage of time for local data processing (i.e., “CPI (Local) percentage in time”) is an important factor in calculating the total number of cycles needed for the data stack processing. The Processor Load threshold allows a user to determine an upper limit of usage of a processor's or a processing core's computing capacities. In some embodiments, the Processor Load threshold can range from 20-70%. For example, a 35% Processor Load threshold indicates that if a proposed processing results in the processor load to exceed 35%, an additional processor or processing core may be needed.

The micro controller specification 315 enables a user to specify the characteristics of a microcontroller (μC) or a secondary processor to be used in data processing. The micro controller specification 315 can be similar to the main processor specifications 313. In other words, the micro controller specification 315 can also include a clock rate, CPI (local) (time %), CPI (External) (time %), and a Processor Load threshold. In some embodiments, however, the clock rate of a micro controller is typically lower than the clock rate of a main processor. The CPI of a micro controller is usually smaller than the CPI of a main processor, such that the micro controller can have a fast, deterministic hardware control (e.g., for data plane hardware DPHW shown in FIG. 2).

The user functions 317 can include data plane functions to be implemented and tasks to be executed. The MIPS analysis tool 300 also allows users to specify which processor(s) is(are) to be used to implement a user function. For example, a user can specify that (i) Function A is to be implemented by software in a main processor, (ii) Function B is to be executed by a micro controller or data plane hardware, and (iii) Function C is to be executed by data plane hardware. The user functions 317 can also indicate the names of the functions, the function being downlink or unlink; numbers of instructions for implementing the functions, as well as the frequency of executing the functions (e.g., once per packet, per symbol, per slot, per logical channel, or asynchronously executed).

Simulation Module 33

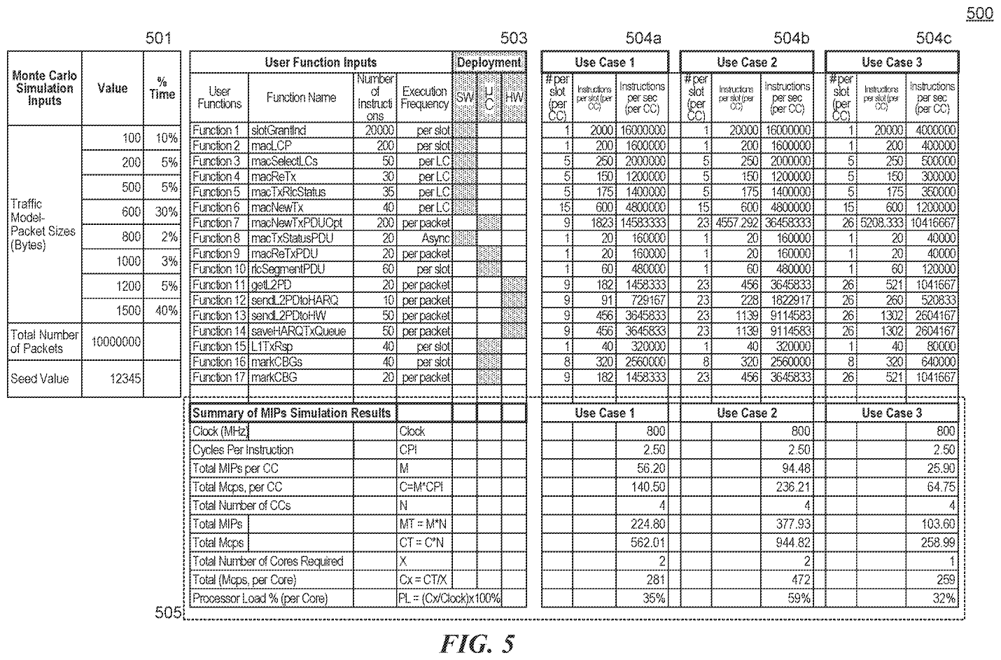

The simulation module 33 performs a Monte Carlo simulation for both DL and UL packets. To perform the Monte Carlo simulation, the simulation module 33 includes a traffic model input submodule 331 to set up a traffic model. The traffic model provides parameters and initial values for the Monte Carlo simulation to run. In some embodiments, the traffic model includes user-specified simulation parameters such as packet sizes (e.g., 100, 200, 500, 600, 800, 1000, 1200, 1500 bytes, etc.) and corresponding percentages in time (10%, 5%, 5%, 30%, 2%, 3%, 5%, 40%, etc.), the total number of packets for each use case (e.g., 10000000 packets), and a seed value (e.g., 12345) for the simulation. An example of the traffic model can be found in FIG. 5 (component 501). The traffic model input submodule 331 also sets up (1) a number of packets to be run for each use case and (2) a seed value for the Monte Carlo simulation (e.g., by user input or empirical data).

The simulation module 33 includes an information import submodule 333 configured to import the user input information from the input module 31. Once the traffic model is set and the user input information has been imported, the simulation module 333 can run the simulation and calculate the total MIPS and cycles per second for each use case (both for DL and UL).

The simulation module 33 includes an instruction mapping submodule 335 configured to generate an instruction mapping for each use case and for each packet size specified in the traffic model. The generated instruction mapping includes user functions to be simulated.

For each user function in this instruction mapping, the total number of instructions per second per CC (I) is calculated. The number “I” relates to (i) an instruction number of the user function, as well as (ii) a number of executions in one slot per CC, which can be determined based on factors such as a maximum data rate, a packet size, a slot duration, and a frequency of execution (e.g., synchronously executed, such as once per packet, per symbol, per slot, per LC, or asynchronously executed, etc.)

In some embodiments, the total number of instructions per second per CC (I) can be calculated based on Equation (A) below.

I=(A*R)/(S*N) Equation (A)

In Equation (A), “A” stands for the number of instructions for the user specified function. “R” refers to the maximum data rate. “S” is the packet size. “N” stands for the total number of component carriers. Parameters “A,” “R,” “S,” and “N” can be obtained or derived from the user input information and the traffic model. Equation (A) is for the user functions that are executed at a “per packet” level.

In some embodiments, the total number of instructions per second per CC (I) can be calculated based on Equation (B) below.

I=(A*P)/(T) Equation (B)

In Equation (B), “A” stands for the number of instructions for the user specified function. “P” refers to the number of sub Protocol Data Unit of Media Access Control (MacSubPDUs) per slot, per component carrier. “T” is the slot duration. Parameters “A,” “P,” and “T” can be obtained or derived from the user input information and the traffic model. Equation (B) is for the user functions that are executed at a “per slot” level.

The simulation module 33 includes an MIPS calculation submodule 337 configured to perform the Monte Carlo simulation. After the instruction mapping is created for each use case for various packet sizes, the MIPS calculation submodule 337 start to calculate the MIPS for each use case based on the instruction mapping and the traffic model.

In some embodiments, the MIPS calculation submodule 337 can randomly vary packet sizes in a vicinity range of the packer size “S” for a specified percentage of time. Accordingly, packets can be randomly generated for a slot, and the MIPS calculation submodule 337 can obtain simulation results of MIPS for each slot.

In some embodiments, in each run of the simulation for each use case, the MIPS calculation submodule 337 can randomly generate multiple packets based on the imported user input information (e.g., by the information import submodule 333) and the traffic model (e.g., by the traffic input submodule 331).

The generated packets are used to compose Media Access Control (MAC) Protocol Data Unit per Carrier Component (MAC PDU per CC) for each slot and for each second. The MIPS calculation submodule 337 can then calculate a processing load (e.g., represented in MIPS and Mcps) for each of the use cases, so as to generate a simulation result for all the use cases. Examples of the simulation result can be found in FIG. 5 (component 505)

Recommendation Module 35

Based on the simulation result for all the use cases, the recommendation module 35 can provide recommendations regarding configurations of processing cores for data stack architectural designs. For example, based on the simulated MIPS and Mcps for each cases, the recommendation module 35 is able to provide recommendations how many and which type of processors to be used for each cases.

In the illustrated embodiment in FIG. 3, the recommendation module 35 can provide a summary 351 of the recommendations. According to the summary 351, it is recommended to have five “data plane main processor cores” (three for downlink processing and two for uplink processing) and six “data plane micro controller cores” (three for downlink processing and two for uplink processing) for the use cases simulated.

By this arrangement, the MIPS analysis tool 300 enables users to design the architecture of 5G UE data stacks effectively and efficiently to accommodate the needs of various products with different user functions. In addition, the MIPS analysis tool 300 allows the users to explore architecture design options iteratively, conveniently, and accurately, and to customize their architecture designs to achieve desirable performance.

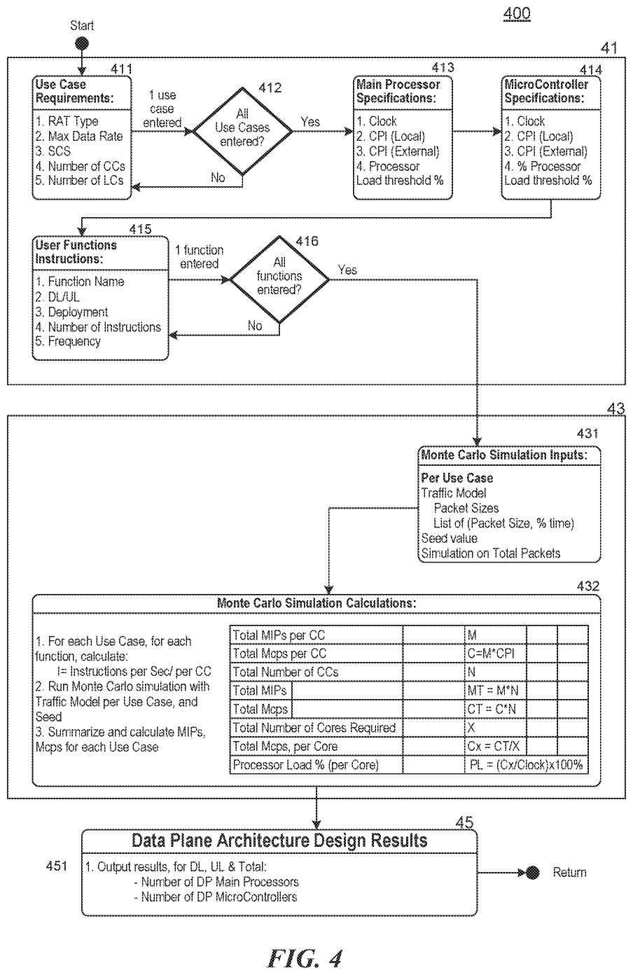

FIG. 4 is a flowchart illustrating processes of the components of an MIPS analysis tool 400 in accordance with one or more implementations of the present disclosure. The analysis tool 400 can include an input component 41, a simulation component 43, and a recommendations component 45. In some embodiments, the components 41, 43, and 45 of the MIPS analysis tool 400 can be implemented as a device, a chip, instructions stored in a storage device, and/or other suitable implementations.

At Step 411, the input component 41 receives a first input from a user. The first input includes use case requirements such as “RAT Type,” “Max Data Rate,” “SCS,” “Number of CCs” and/or “Number of LCs.” At Step 412, the input component 41 determines whether all use cases to be simulated are inputted. If negative, the process goes back to step 411. If affirmative, the process goes to Step 413, where input component 41 receives a second input from the user. The second input includes main processor specifications of one or more main processors to be simulated. The second input can include “Clock,” “CPI (Local),” “CPI (External),” “Processor Load threshold (%),” etc.

At Step 414, the input component 41 receives a third input from the user. The third input includes micro controller specifications of one or more micro controllers to be simulated. Similar to the second input, the third input can also include “Clock,” “CPI (Local),” “CPI (External),” “Processor Load threshold (%),” etc.

At Step 415, the input component 41 receives a fourth input from the user. The fourth input includes information related to user functions to be simulated, such as, “Function Name,” “DL or UL,” “Deployment,” (e.g., implemented by software in a main processor, by a micro controller, or by data plane hardware) “Number of Instructions,” “execution frequency,” etc.

At Step 416, the input component 41 determines whether all the user functions to be simulated are inputted. If negative, the process goes back to Step 415. If affirmative, the input component 41 exports or transmits received inputs to the simulation component 43 for further processes.

At Step 431, the simulation component 43 starts to establish a traffic model as an input for a Monte Carlo Simulation process. The traffic model includes packet size values (bytes) to be run for each use case and corresponding time percentage values. For example, the packet size values can be 50, 100, 200, 500, 600, 800, 100, 1200, 1500, 2500 bytes (i.e., 10 types of packet size values), and the corresponding time percentage values can be 10% for each type of packet size (i.e., 100% in total).

The simulation component 43 can also set a total number of packets to be simulated. In some embodiments, the total number of packets to be simulated can range from 10,000 to 1,000,000,000. The simulation component 43 can also set a seed value for the Monte Carlo simulation. The seed value is an initial value or a starting point for a sequence of pseudorandom numbers generated by the Monte Carlo simulation. With the same seed values, the same sequence of pseudorandom numbers are generated.

In some embodiments, the traffic model, the total number of packets, and the seed value can be determined by the users. In some embodiments, however, the traffic model, the total number of packets, and the seed value are preset values in the simulation component 43. These preset values can be determined based on empirical study and analyses.

At Step 432, the simulation component 43 calculates the total number of instructions per second per CC (I), and then runs the Monte Carlo simulation for each use cases. The result of the simulation can be summarized as Table 1 below as the Table shown in FIG. 4.

TABLE 1

| | |
|---|---|
| Clock (MHz) | Clock |
| Cycles Per Instruction | CPI |
| Total MIPS per CC | M |
| Total Mcps, per CC | C = M*CPI |
| Total Number of CCs | N |
| Total MIPS | MT = M*N |
| Total Mcps | CT = C*N |
| Total Number of Cores Required | X |
| Total (Mcps, per Core) | Cx = CT/X |
| Processor Load % (per Core) | PL = (Cx/Clock) × 100% |

“Total MIPS per CC” can be noted as “M.” “Total Mcps per CC” can be noted as “C” which can be calculated based on equation “C=M*CPI.” “CPI” refers to “Cycles per Instructions.” “Total Number of CC” can be noted as “N.” Accordingly, “Total MIPS” (MT) equals to “M*N,” and “Total Mcps” (CT) equals to “C*N.”

“Total Number of Cores Required” can be set as “X.” Accordingly, “Total Mcps per Core” (Cx) can “CT/X.” “The Processor Load Percentage (per Core)” (PL) can be determined by equation “PL=(Cx/Clock)×100%,” wherein “Clock” is the Clock value in MHz.

At Step 451, based on the simulation result of all the use cases, the recommendations component 45 can generate recommendations the numbers and types of processors to be used in a data stack design.

FIG. 5 is a schematic diagram illustrating a user interface 500 showing information in accordance with one or more implementations of the present disclosure. In Section 501, information associated with inputs for Monte Carlo simulations can be displayed. These inputs include “Traffic Model,” “Total Number of Packets,” and “Seed Value.”

In Section 503, information associated with user functions can be displayed. As illustrated, Functions 1-17 are listed, each with detailed information for “Number of Instructions,” “Execution Frequency,” and “Deployment.” Note that the “Deployment” information indicates that the user function is to be executed by software SW (e.g., implemented by a main processor), micro controller (μC), or data plane hardware (DPHW). In some embodiments, some user functions can be implemented by a combination of SW, μC, and/or HW.

In Sections 504a, 504b, and 504c, three use cases 1, 2, and 3 are displayed. As shown, values such as “Packet Number per slot (per CC),” “Instructions per slot (per CC),” and “Instructions per sec (per CC)” can be displayed for user's quick reference.

In Section 505, the simulation results for the use cases are summarized in tables. In the illustrated embodiment, these tables are in the same format as Table 1 discussed above. In other embodiments, however, the simulation results can be presented in other suitable ways, such as in a chart, a diagram, etc.

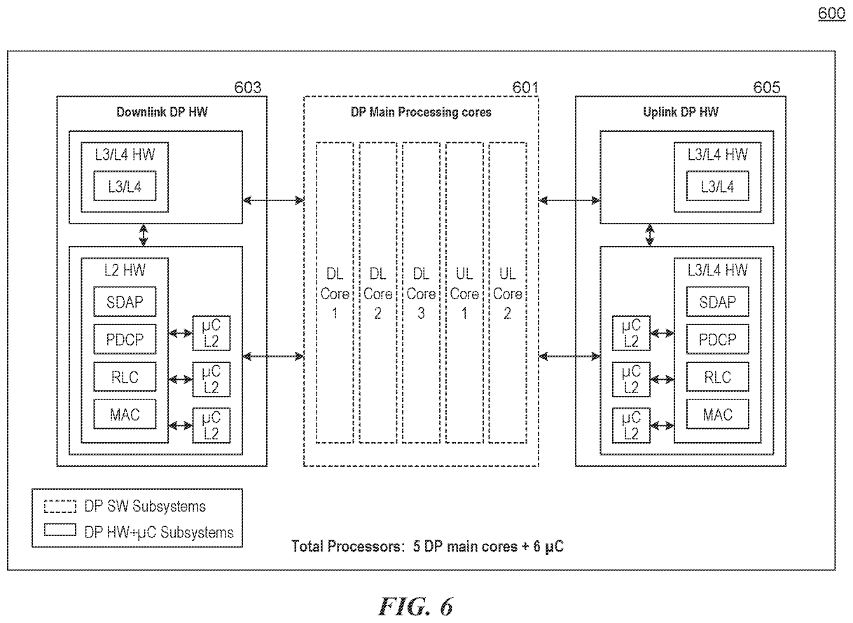

FIG. 6 is a schematic diagram illustrating a recommended configuration 600 of processor cores for a data stack in accordance with one or more implementations of the present disclosure. The recommended configuration 600 suggests a data stack design with five main processing cores 601, which includes DL cores 103 and UL cores 1 and 2. The main processing cores 601 can be implemented by software in main processors (of a UE, for example). The recommended configuration 600 includes suggestions for downlink data plane hardware 603, which includes L2/L3/L4 hardware with three L2 micro controllers. Similarly, the recommended configuration 600 also includes suggestions for uplink data plane hardware 605, which includes L2/L3/L4 hardware with three L2 micro controllers. In the illustrated embodiments, five data plane main processing cores and six micro controllers are recommended to implement the simulated user function. The recommended configuration 600 can vary depending on different user functions.

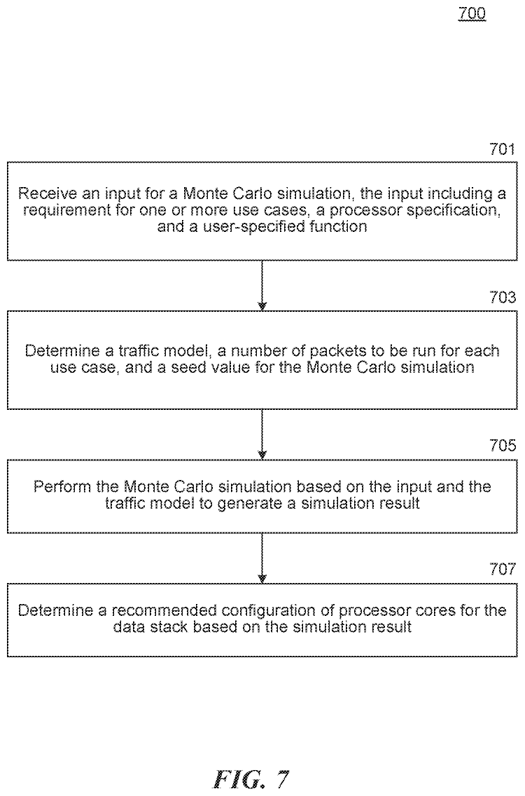

FIG. 7 is flowchart illustrating a method 700 in accordance with one or more implementations of the present disclosure. The method 700 is for performing a Million Instructions per Second (MIPS) analysis for a data stack of a user equipment (UE). At Block 701, the method 700 includes receiving an input for a Monte Carlo simulation, the input including a requirement for one or more use cases, a processor specification, and a user-specified function.

In some embodiments, the requirement for the one or more use cases can include a type of Radio Access Technology (RAT), a Maximum Data Rate (MDR), a SubCarrier Spacing (SCS), a number of Component Carriers (CCs), and/or a number of Logical Channels (LCs).

In some embodiments, the processor specification can include a number of main processors to be used and a number of micro controllers to be used for the one or more use cases. The processor specification can also include a clock rate, a local Cycles Per Instruction (CPI), an external CPI, and/or a processor load threshold. The processor specification can include specifications of a main processor of the UE, a micro controller, and/or data plane hardware.

In some embodiments, the user-specified function can include information indicating: a name of the function, a number of instructions to be executed for the function, an execution frequency for the instructions to be executed, and/or information indicating that the instructions to be executed are downlink (DL) or uplink (UL).

In some embodiments, the user-specified function can be a function that can be implemented by more than two processing units (SW, μC, and DPHW). For example, the user-specified function can be a main-processor functional partition to be deployed on a data-plane main processor, a micro-controller functional partition to be deployed on a data-plane micro controller, and/or a data-plane-hardware functional partition to be deployed on data plane hardware.

At Block 703, the method 700 includes determining a traffic model, a number of packets to be run for each use case, and a seed value for the Monte Carlo simulation. The traffic model can be determined based on multiple packet sizes and a distribution (e.g., time percentages) corresponding to the multiple packet sizes. The number of packets to be run for each use case is a large number of the total packets to be simulated. The seed value is an initial valuer for the Monte Carlo simulation.

At Block 705, the method 700 includes performing the Monte Carlo simulation based on the input and the traffic model to generate a simulation result. In some embodiments, the Monte Carlo simulation is performed the number of packets to be run for each use case is reached

At Block 707, the method 700 includes determining a recommended configuration of processor cores for the data stack based on the simulation result. In some embodiments, the method 700 can further include determining, based on the simulation result, a total MIPS per component carrier (M). Based on the total MIPS per component carrier, the method 700 can further determine a total cycles per second (C), a total number of MIPS (MT), and a total number of Mcps (CT).

In some embodiments, the recommended configuration of processor cores can include types and number of processing units (SW, μC, and DPHW) to be used, for both uplink and downlink data processing. In some embodiments, the method 700 can also be used to simulate hardware capacities of other types of devices, such as memories or storage devices.

### Example Devices and Systems

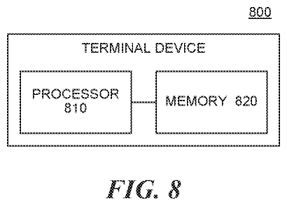

FIG. 8 is a schematic block diagram of a terminal device 800 (e.g., an example of the terminal device 103 of FIG. 1) in accordance with one or more implementations of the present disclosure. As shown in FIG. 8, the terminal device 800 includes a processing unit 610 (e.g., a DSP, a CPU, a GPU, etc.) and a memory 620. The processing unit 810 can be configured to implement instructions that correspond to the terminal device 800.

It should be understood that the processor in the implementations of this technology may be an integrated circuit chip and has a signal processing capability. During implementation, the steps in the foregoing method may be implemented by using an integrated logic circuit of hardware in the processor or an instruction in the form of software. The processor may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor may be a microprocessor, or the processor may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory, and the processor reads information in the memory and completes the steps in the foregoing methods in combination with the hardware thereof.

It may be understood that the memory in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type.

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The terms “coupled” and “connected,” along with their derivatives, can be used herein to describe structural relationships between components. It should be understood that these terms are not intended as synonyms for each other. Rather, in particular implementations, “connected” can be used to indicate that two or more elements are in direct contact with each other. Unless otherwise made apparent in the context, the term “coupled” can be used to indicate that two or more elements are in either direct or indirect (with other intervening elements between them) contact with each other, or that the two or more elements cooperate or interact with each other (e.g., as in a cause-and-effect relationship, such as for signal transmission/reception or for function calls), or both. The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A method for a performance analysis on a data stack of a user equipment (UE), the method comprising:
receiving an input for a Monte Carlo simulation, the input including a requirement for one or more use cases, a processor specification, and a user-specified function;
determining a traffic model, a number of packets to be run for each use case, and a seed value for the Monte Carlo simulation, wherein the traffic model includes multiple packet sizes and a distribution corresponding to the multiple packet sizes;
performing the Monte Carlo simulation based on the input, the traffic model, the number of packets to be run for each use case, and the seed value so as to generate a simulation result; and
determining a recommended configuration of processor cores for the data stack based on the simulation result.

2. The method of claim 1, further comprising:
generating, prior to performing the Monte Carlo simulation, an instruction mapping for each of the one or more use cases;
wherein the instruction mapping includes a total number of instructions (I) per second per component carrier.

3. The method of claim 2, wherein the total number of instructions (I) per second per component carrier is calculated based on:
a number of instructions for the user specified function (A);
a maximum data rate (R);
a packet size (S); and
a total number of component carriers (N).

4. The method of claim 3, wherein the total number of instructions per second per component carrier (I) is calculated based on the following equation:
I=(A*R)/(S*N).

5. The method of claim 2, wherein the total number of instructions (I) per second per component carrier is calculated based on:
a number of instructions for the user specified function (A);
a number of sub Protocol Data Unit of Media Access Control (MacSubPDUs) per slot, per component carrier (P); and
a slot duration (T).

6. The method of claim 5, wherein the total number of instructions per second per component carrier (I) is calculated based on the following equation:
I=(A*P)/(T).

7. The method of claim 1, further comprising:
performing the Monte Carlo simulation based on the input and the traffic model until the number of packets to be run for each use case is reached.

8. The method of claim 1, further comprising:
determining, based on the simulation result, a total MIPS per component carrier; and
determining, based on the total MIPS per component carrier, a total cycles per second, a total number of MIPS, and a total number of Million Cycles per Second (Mcps).

9. The method of claim 8, further comprising:
determining the recommended configuration of processor cores for the data stack based on the total cycles per second, the total number of MIPS, and the total number of Mcps.

10. The method of claim 1, wherein the requirement for the one or more use cases includes a type of Radio Access Technology (RAT), a Maximum Data Rate (MDR), a SubCarrier Spacing (SCS), a number of Component Carriers (CCs), and/or a number of Logical Channels (LCs).

11. The method of claim 1, wherein the processor specification includes a number of main processors to be used and a number of micro controllers to be used for the one or more use cases.

12. The method of claim 1, wherein the processor specification includes:
a clock rate;
a local Cycles Per Instruction (CPI);
an external CPI; and/or
a processor load threshold.

13. The method of claim 1, wherein the user-specified function includes information indicating one or more of the following:
a number of instructions to be executed;
an execution frequency for the instructions to be executed; and/or
information indicating that the instructions to be executed are downlink (DL) or uplink (UL).

14. The method of claim 1, wherein the user-specified function includes:
a main-processor functional partition to be deployed on a data-plane main processor;
a micro-controller functional partition to be deployed on a data-plane micro controller; and/or
a data-plane-hardware (DPHW) functional partition to be deployed on data plane hardware.

15. An apparatus for performing a Million Instructions per Second (MIPS) analysis for a data stack of a user equipment (UE), the apparatus comprising:
a memory;
a processor coupled to the memory and configured to:
receive an input for a Monte Carlo simulation, the input including a requirement for one or more use cases, a processor specification, and a user-specified function;
determine a number of packets to be run for each use case, and a seed value for the Monte Carlo simulation, wherein the traffic model includes multiple packet sizes and a distribution corresponding to the multiple packet sizes;
perform the Monte Carlo simulation based on the input, the traffic model, the number of packets to be run for each use case, and the seed value so as to generate a simulation result; and
determine a recommended configuration of processor cores for the data stack based on the simulation result.

16. The apparatus of claim 15, wherein:
the requirement for the one or more use cases includes a type of Radio Access Technology (RAT), a Maximum Data Rate (MDR), a SubCarrier Spacing (SCS), a number of Component Carriers (CCs), and/or a number of Logical Channels (LCs);
the processor specification includes a number of main processors to be used and a number of micro controllers to be used for the one or more use cases; and
the user specified function includes (i) a main-processor functional partition to be deployed on a data-plane main processor, (ii) a micro-controller functional partition to be deployed on a data-plane micro controller, and/or (iii) a data-plane-hardware (DPHW) functional partition to be deployed on data plane hardware.

17. The apparatus of claim 15, wherein the processor is further configured to:
generate, prior to performing the Monte Carlo simulation, an instruction mapping for each of the one or more use cases;
wherein the instruction mapping includes a total number of instructions (I) per second per component carrier.

18. The apparatus of claim 17, wherein the total number of instructions (I) per second per component carrier is calculated based on:
a number of instructions for the user specified function (A);
a maximum data rate (R);
a packet size (S); and
a total number of component carriers (N), and
wherein the total number of instructions per second per component carrier (I) is calculated based on the following equation:
I=(A*R)/(S*N).

19. The apparatus of claim 17, wherein the total number of instructions (I) per second per component carrier is calculated based on:
a number of instructions for the user specified function (A);
a number of sub Protocol Data Unit of Media Access Control (MacSubPDUs) per slot, per component carrier (P); and
a slot duration (T), and
wherein the total number of instructions per second per component carrier (I) is calculated based on the following equation:
I=(A*P)/(T).

20. A non-transitory, computer-readable medium having processor instructions stored thereon that, when executed by one or more processors, cause the one or more processors to perform a method, the method comprising:
receiving an input for a Monte Carlo simulation, the input including a requirement for one or more use cases, a processor specification, and a user-specified function;
determining a traffic model, a number of packets to be run for each use case, and a seed value for the Monte Carlo simulation, wherein the traffic model includes multiple packet sizes and a distribution corresponding to the multiple packet sizes;
performing the Monte Carlo simulation based on the input, the traffic model, the number of packets to be run for each use case, and the seed value so as to generate a simulation result; and
determining a recommended configuration of processor cores for the data stack based on the simulation result.
